(19) United States
(12) Patent Application Publication
(10) Pub. No.: US 2003/0015521 A1
(43) Pub. Date: Jan. 23, 2003

(54) Ceramic heater

(75) Inventor: Yasutaka Ito, Gifu (JP)

Correspondence Address: OLIFF & BERRIDGE, PLC, P.O. Box 19928, Alexandria, VA, 22320, US

(73) Assignee: Ibiden Co., Ltd.

(21) Appl. No.: 10/217,029

(22) Filed: Aug. 13, 2002

Related U.S. Application Data
(63) Continuation of application No. 09/917,749, filed on Jul. 31, 2001.
Application No. 09/917,749 is a continuation of application No. PCT/JP00/00815, filed on Feb. 15, 2000.

(30) Foreign Application Priority Data
Nov. 19, 1999 (JP) 11-330270
Nov. 26, 1999 (JP) 11-335641

(51) Int. Cl. H05B 3/68

(52) U.S. Cl. 219/544; 219/468.1

(57) ABSTRACT

The present invention provides a ceramic heater having better anti thermal shock property. A ceramic substrate 12 is formed by providing heat generation bodies 14a and 14b on the surface of a green sheet made from a slurry containing powdered ceramics, sandwiching the green sheet with other green sheets from both upper and lower sides and then laminating and pressing the compiled green sheets. At least some of the heat generation bodies 14a and 14b are disposed on a level P1b offset from a level P1a of other heat generation bodies in the direction of thickness of the ceramic substrate 12.

### TECHNICAL FIELD

The present invention relates to a ceramic heater, and more particularly to a ceramic heater for use in production and inspection processes of semiconductors.

### BACKGROUND ART

Applied semiconductor products are indispensable in many industrial fields. As a typical example, semiconductor chips are produced by slicing a silicon monocrystalline to a predetermined thickness to produce a silicon wafer, on which are formed a variety of circuits.

In the production process of such variety of circuits, high frequency spattering technique or plasma etching technique may be used for heating the silicon wafer in order to form components such as conductive thin films thereon. In order to successfully achieve the high frequency spattering or plasma etching, ceramic heaters have been become popular in recent years, which is made of sintered ceramic materials.

As a type of ceramic heater, one incorporating a resistive heat-generation body (referred to as a heat generation body herein below) within a ceramic substrate, called a ceramic heater of built-in heat generation body type, is well known in the art. Referring to FIG. 13, which shows an example of a ceramic substrate 202 of a ceramic heater 200 in a cross-sectional view, the section was made in a plane normal to the longitudinal axis of a heat generation body 204 having a flat-profile.

As shown in FIG. 13, the ceramic heater 200, with a heat generation body built-in, has heat generation bodies 204 made of conductive material formed together on the same plane P in a predetermined pattern within the ceramic substrate 202, some recesses 206 are provided for part of some of respective heat generation bodies 204 in order to attach, to the recesses 206, a terminal (not shown in the figure) for connecting to a power supply (not shown in the figure), which is connected to the terminal through a wiring.

The ceramic substrate 202 incorporating such heat generation bodies 204, may be produced by using a method of obtaining a ceramic substrate by laminating and pressurizing and baking green sheets made of slurry including powdered ceramic materials. On a surface of a green sheet, heat generation bodies are disposed in accordance with a given pattern specified, then the green sheet with heat generation bodies disposed may be appropriately sandwiched by a plurality of green sheets on both upper and bottom sides to pressurize and bake them together.

Thus obtained ceramic substrate is used as a heater core to form a heater device by disposing the heater substrate at the upper opening of a casing with U-shaped section (not shown). A silicon wafer to be heated (not shown) is set on the upper side of the heater device, and in this configuration the electric power supply is connected to the power connector terminals of the heater substrate to heat the silicon wafer.

As can be appreciated, in the conventional ceramic heater, from the viewpoint of structural metallography of the ceramic substrate, the heat generation body built-in may introduce discontinuity in the structure of sintered ceramic body. Thus the Prior Art may suffer from the problem of thermal shock applied to the ceramic substrate by the expansion or shrinkage of the heater core at the time of heat-up or cool-down, due to the difference of thermal expansion rate at the sites of discontinuity.

The amount of thermal shock may be given as ΔT of the ceramic substrate. When the heat generation bodies are embedded in the ceramic substrate there is a problem arising that the ΔT of the ceramic substrate may decrease to approximately 150° C. due to the thermal shock.

The primary object of the present invention therefore is to provide a ceramic heater with an excellent anti thermal shock property by altering the location of embedding the heat generation bodies.

### DISCLOSURE OF INVENTION

The inventors of the present invention have studied on the cause of ΔT of the ceramic substrate and discovered the reduction of ΔT of the ceramic substrate comes from the fact that the stress is concentrated to a heat generation body layer because the heat generation bodies having thermal expansion rate different to that of the ceramic substrate are formed in one single layer.

The fact based on the fundamental experiments conducted by the authors also revealed that the anti thermal shock property of the ceramic heater is better if the position of each heat generation body is varied than if the distance between heat generation bodies in the direction of thickness within the ceramic substrate is even. The inventors of the present invention has proposed, on the basis of these findings, a structure with the positional arrangement of heat generation bodies being varied in the direction of thickness of the ceramic substrate, to achieve this novel invention.

In order to solve the above-identified problem, a ceramic heater according to claim 1 in accordance with the present invention comprises heat generation means disposed embedded in a ceramic substrate, at least some of the heat generation means being formed so as to be located in positions in the direction of thickness of the ceramic substrate different from the location of others of the heat generation means.

In accordance with the ceramic heater having such structural arrangement, if thermal shock is applied to the part of formed heat-generation bodies which is the discontinuity section of the ceramic sintered body to cause the expansion or shrinkage when heating or cooling respectively, the amount ΔT of the ceramic substrate will not decrease since at least some of the heat generation means are formed in positions in the direction of thickness of the ceramic substrate different from the location of others of the heat generation means. The ceramic substrate in accordance with the present invention may be used in the temperature range between 150 and 180° C. depending on its application.

In this case, according to claim 2 of the present invention, the heat generation means may be formed such that the part adjacent to the next is varied in different positions in the direction of thickness of the ceramic substrate. In the case where a thermal shock is applied to cause the expansion or shrinkage when heating up or cooling down respectively, the expansion or shrinkage at each part in the heat generation means is dispersed to mutually different planes so as to avoid an excessive stress concentration.

In this case, according to claim 3 of the present invention, the heat generation means may be of the sectional form of flat-profile.

In this case, according to claim 4 of the present invention, the amount of offset at the mutually adjacent sections may preferably be in the range of 1 to 100 μm. In such a range, the effect of thermal shock may be finely dispersed in the direction of thickness of the ceramic substrate and to be reduced. Here it should be noted that the amount of offset may be defined as the distance between the center points in the direction of thickness of the ceramic substrate, by polishing the section of the ceramic substrate and determining the crossing points of diagonal lines across the corners in the section of the heat generation means as the center point by means of an optical microscope or an electron microscope (see δt of FIG. 1).

In this case, as according to claim 5 of the present invention, the maximum amount of offset of the locations may preferably be in the range of 3 to 500 μm. The maximum amount of offset less than 3 μm is insufficient to have an effect of disperse the expansion or shrinkage of the ceramic substrate, while on the other hand the maximum amount of offset more than 500 μm may invoke another problem of uniformity of thermal distribution on the surface of the ceramic heater. Here it should be noted that the ‘maximum amount of offset’ may be defined by the distance δtmax in the direction of thickness between the lowest level and the highest level as shown in FIG. 2; that the amount of offset between mutually adjacent parts (of heat generation bodies) may be defined by the distance δt in the direction of thickness between the cross-sectional center points of ‘mutually adjacent parts (of heat generation bodies)’ as shown in FIG. 1 and FIG. 10(f).

In addition, as according to claim 6, in case of claims 1 or 2, the heat generation means may be formed from a spiral wire body.

In this case, as according to claim 8, the maximum amount of offset of the locations may be preferably in the range of 5 to 2000 μm. The maximum amount of offset less than 5 μm may be insufficient to have the effect of offset, while the amount more than 2000 μm may arise another problem of uniformity of thermal distribution on the surface of the ceramic substrate. Here the ‘maximum amount of offset’ in case of spiral form, may be defined as the distance between the lowest level and the highest level of the center points in the direction of thickness of the ceramic substrate, which center points may be determined by treating the cross-section as a circle or a oval to define as the distance between the lowest level and the highest level of the center points in the direction of thickness of the ceramic substrate (see FIG. 9(f)), however if the spiral form is considered to be a continuity of circles having the same diameter of cross-section, or to be a continuity of ovals having the same diameter in shorter axis as in longer axis, the maximum value may be defined as the amount of offset at the top or bottom edge of the spiral. Also it should be noted that the amount of offset between ‘mutually adjacent parts (of heat generation body)’ may be defined as the distance between the center points of the mutually adjacent heat generation bodies.

In this case, as according to claim 9, electrostatic electrodes may be provided on the ceramic substrate. The ceramic heater in accordance with the present invention may thereby be used as an electrostatic chuck. In addition, as according to claim 10, a chuck-top conductor layer may be formed on top of the surface of the ceramic substrate. The ceramic heater in accordance with the present invention may thereby be used as a wafer probe.

The ceramic substrate, which constitutes the primary element of the ceramic substrate in accordance with the present invention, may be preferably made by using a sintered substrate of aluminum nitride. The material used for the ceramic substrate is not limited to aluminum nitride, indeed other ceramic materials such as ceramic carbonate, ceramic oxide, ceramic nitride and the like may also be equally used instead.

Some examples of ceramic carbonates include, by way of examples not limitative, silicon carbide, zirconium carbide, titanium carbide, tantalum carbide, tungsten carbide and the like. Some examples of ceramic oxides include, by way of examples not limitative, alumina, zirconia, cordierite, mullite and the like. Some examples of nitrides include, by way of examples not limitative, other than the aluminum nitride as described above, silicon nitride, boron nitride, titanium nitride and the like.

Among these ceramic materials, in general, nitride ceramics, and carbonate ceramics are preferred to oxide ceramics because of their thermal conductivity. The sintered bodies may be of single material or of a plurality of materials.

### BRIEF DESCRIPTION OF THE DRAWINGS

FIG. 1 is a cross-sectional side elevation view showing primary parts of a ceramic substrate of a ceramic heater in accordance with an embodiment of the present invention;

FIG. 2 is a cross-sectional side elevation view showing primary parts of a ceramic substrate of a ceramic heater in accordance with an embodiment of the present invention;

FIG. 3 is a cross-sectional side elevation view showing primary parts of a ceramic substrate of a ceramic heater in accordance with an embodiment of the present invention;

FIG. 4 is a cross-sectional plan view showing primary parts of a ceramic substrate of a ceramic heater in accordance with an embodiment of the present invention;

FIGS. 5(a) and (b) show schematic diagrams of processes for obtaining the positional offset of heat generation bodies in a ceramic substrate of a ceramic heater in accordance with an embodiment of the present invention;

FIGS. 6(a) to (c) is schematic plan views showing the disposition of paste layers in a ceramic substrate of a ceramic heater in accordance with an embodiment of the present invention, in the order of lamination;

FIGS. 7(a) to (c) show schematic diagrams of processes indicating the disposition of paste layers in a ceramic substrate of a ceramic heater in accordance with an embodiment of the present invention, in the order of lamination, and FIG. 7(d) shows a cross-sectional side elevation view after the lamination thereof.

FIG. 8 shows flow diagrams of production of ceramic substrate in accordance with an embodiment of the present invention;

FIG. 9 shows flow diagrams of production of ceramic substrate in accordance with another embodiment of the present invention;

FIG. 10 shows a schematic diagram of electrodes for an electrostatic chuck in accordance with an exemplary application of the present invention;

FIG. 11 shows flow diagrams of production of wafer probe in accordance with an exemplary application of the present invention;

FIG. 12 is a graph showing the results of a bending resistance test after a thermal shock test; and

FIG. 13 is a cross-sectional side elevation view showing the primary parts of a conventional ceramic substrate.

### BEST MODE FOR CARRYING OUT THE INVENTION

One preferred embodiment in accordance with the present invention will now be described below in greater details with reference to accompanying drawings.

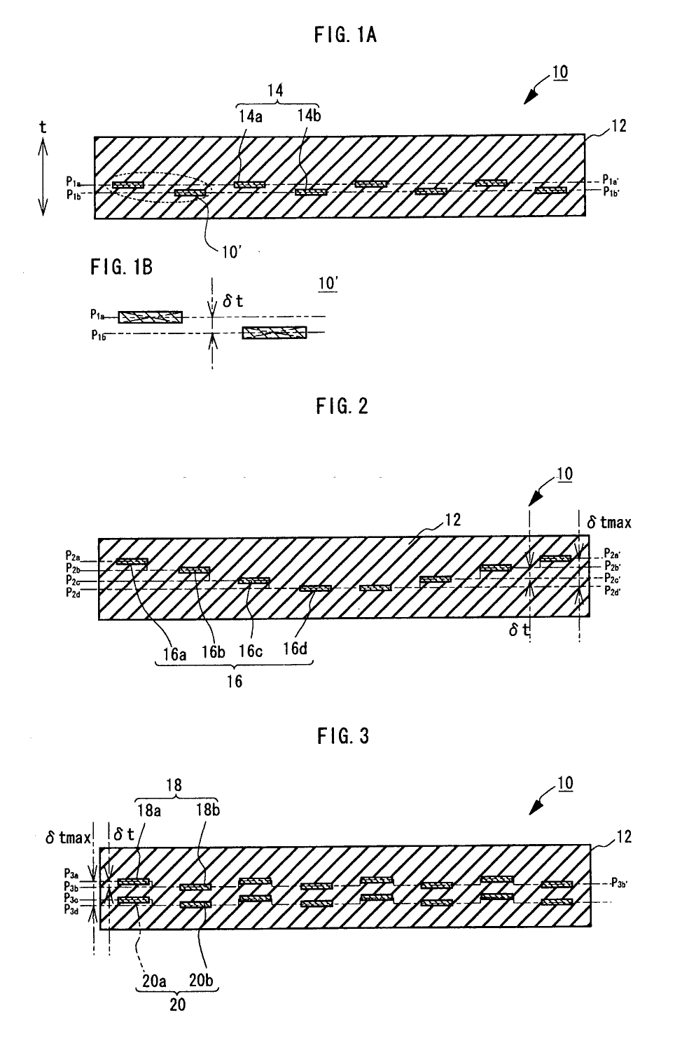

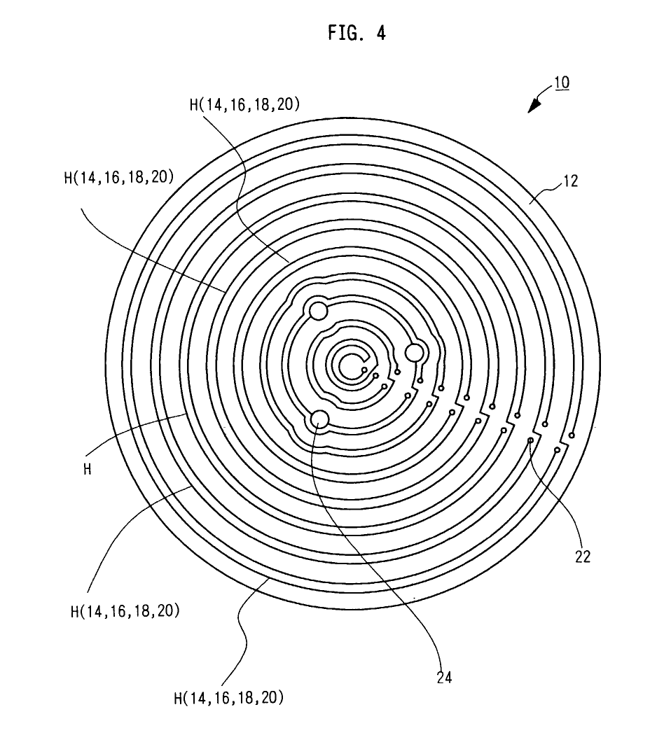

In FIGS. 1 to 3, there are shown cross-sectional elevation views of a ceramic substrate 12 of a ceramic heater 10 in accordance with the present invention, which are cross-sectional side elevation views in which the ceramic substrate 12 is cut in the direction of thickness t, in a plane perpendicular to the longitudinal axis of heat generation bodies 14, 16, 18 and 20, which are in the form of ribbons with a width. FIG. 4 depicts in a schematic manner the planar conductor patterns of the heat generation bodies 14, 16, 18 and 20, by showing a cross-sectional plan view of a horizontal plane including the upper surface of the heat generation bodies 14, 16, 18 and 20 (i.e., P1a P1a′ in FIG. 1; P2b P2b′ in FIG. 2; P3b P3b′ in FIG. 3, and the like).

The cross-sectional side elevation views of FIGS. 1 and 2 are arranged such that the cross-section of the heat generation bodies 14 and 16 are appeared at eight locations, while the cross-sectional side elevation view of FIG. 3 is arranged such that the cross-section of the heat generation bodies 18 and 20 are appeared at sixteen locations, however such arrangement is by way of example, for the purpose of description only. The number of disposed bodies is therefore arbitrary. In addition, as shown in FIG. 4, when referring to all of the heat generation bodies 14, 16, 18 and 20, these bodies will be designated to ‘heat generation body H’. Also in the figure, the reference numeral 22 designates to a terminal section of heat generation body H, and the reference numeral 24 to an insertion hole for support pins for supporting a semiconductor wafer. The heat generation body H in the proximity of the insertion hole 24 is disposed so as to pass around the insertion hole 24.

In this case as according to claim 7, it is preferable for the heat generation means that the amount of offset at the mutually adjacent spiral section is in the range of 1 to 500 μm.

Now each of preferred embodiments shown in FIGS. 1 to 3 will be respectively described below in greater details.

The heat generation body 14 shown in FIG. 1 is comprised of a heat generation body 14a and heat generation body 14b, which are disposed at mutually adjacent position, and each of heat generation bodies 14 is disposed so as to be coaxial in plan view (see FIG. 4) in the planes P1a and P1b within the ceramic substrate 12. The level of plane P1a and that of P1b are mutually offset at the amount of offset δt in the direction of thickness t. That is, the ceramic heater 10 is arranged in the direction of thickness t of the ceramic substrate 12 such that the amount of offset of the mutually adjoining heat generation bodies H may be in the range of 1 to 100 μm. This arrangement may allows the effect of thermal shock to be buffered more finely in the direction of thickness of ceramic substrate. The heat generation bodies H are arranged so as to have 5 to 50 μm of thickness. In this arrangement the expansion or shrinkage of the heat generation bodies H at the time of heating or cooling of ceramic substrate 12 may be occurred in the plane P1a and plane P1b, which are mutually offset each from other by an amount δt. This helps dispersion of stress. In the case where the heat generation body is in the spiral form, the heat generation means may preferably have an amount of offset in the mutually adjoining spiral section in the range of 1 to 500 μm.

The heat generation body 16 shown in FIG. 2 is a collection of heat generation bodies 16a, 16b, 16c and 16d, which are disposed in stepping position, and each component of the heat generation body 16 is disposed so as to be coaxial in plan view (see FIG. 4) in the planes P2a, P2b, P2c and P2d within the ceramic substrate 12. The level of four planes P2a, P2b, P2c, P2d is mutually offset each from other by the amount of offset δt in the direction of thickness t, while at the same time the level of two planes P2a and P2d is mutually offset by the maximum amount of offset δtmax, in the direction of thickness t. Thus, the ceramic heater 10 is arranged such that the maximum amount of offset δtmax of the heat generation bodies H may be in the range of 3 to 500 μm and the amount of offset δt of the mutually adjoining heat generation bodies H may be in the range of 1 to 100 μm, both in the direction of thickness t of the ceramic substrate 12. The heat generation bodies H itself are formed to have the thickness of 5 to 50 μm.

In this configuration, the expansion or shrinkage of the heat generation bodies H may be seen on the planes P2a, P2b, P2c and P2d, which are planes mutually offset each from other by the amount of offset δt and with the maximum amount of offset between the farthest planes being δtmax, when heating or cooling of the ceramic substrate 12.

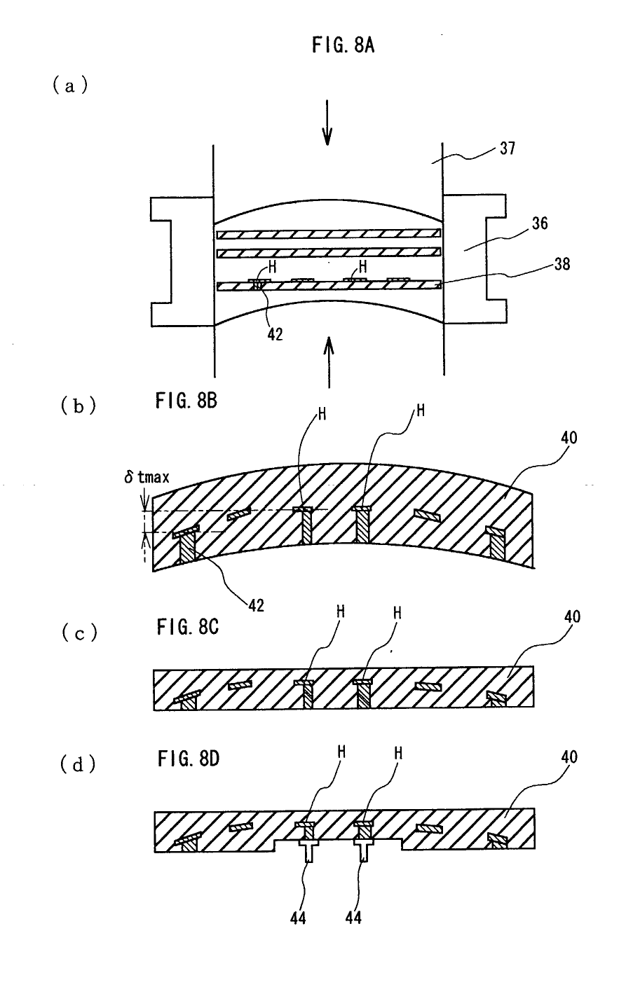

In the case where the heat generation body 16 is arranged as shown in FIG. 2, then for the heat conducting to the entire ceramic substrate 12, the distance from the heating surface to the heat generation body 16c and 16d may differ from the distance to the heat generation body 16a and 16b, that is, the heat generation body nearer to the outer circumference may be disposed nearer to the heating plane. This allows the temperature around the outward periphery to be prevented from decreasing. On the contrary, in the case where the heat generation bodies 16 are arranged to be convex to upper side (see FIG. 8), then inwardly disposed bodies may be nearer to the heating plane so that the decrease of temperature in such inward section may be prevented even if the electrodes are connected beneath the inward heat generation bodies.

Next, the heat generation bodies 18 shown in FIG. 3 designate collectively to the heat generation body 18a and heat generation body 18b, each disposed in mutually adjoining section respectively, and the heat generation bodies 20 designate to collectively the heat generation body 20a and heat generation body 20b, each disposed in mutually adjoining section respectively, these heat generation bodies 18 and 20 may constitute a ‘group of heat generation bodies’. In other words, the ceramic heater 10 shown in FIG. 3 is comprised of two groups of heat generation bodies. In such a configuration, each of the heat generation bodies 18 and 20 is disposed so as to be coaxial in plane view in the planes P3a, P3b, P3c and P3d within the ceramic substrate 12 (see FIG. 4). Two pairs of planes, planes P3a and P3b, and planes P3c and P3d, are mutually offset each from other by an amount of offset δt in the direction of thickness t, the location of two planes P3a and P3d are still further offset mutually by the maximum amount of offset δtmax in the direction of thickness t. Thus the ceramic heater 10 is arranged in the direction of thickness t of the ceramic substrate such that the maximum amount of offset of the heat generation bodies H 67 tmax may be in the range of 3 to 500 μm, while at the same time the amount of offset between the mutually adjoining heat generation bodies H δt may be in the range of 1 to 100 μm. The heat generation bodies H are arranged so as to have 5 to 50 μm of thickness. Here it should be noted that the number of ‘group of heat generation bodies’ may not be limited to two, rather a plurality of groups more than two may be provided.

As can be seen from the foregoing discussion, in accordance with the arrangement shown in FIG. 1 through FIG. 3, the heat generation bodies 14, 16, 18 and 20 may be located such that at least some of heat generation bodies H are offset from others in terms of the direction of thickness t of the ceramic substrate 12. In this arrangement when heating or cooling the ceramic substrate 12, the expansion or shrinkage of the heat generation bodies H may be occurred on the planes that are mutually set off each other by the amount of offset δt, or on the planes that are mutually offset each other by the amount of offset δt and that the maximum amount of offset between farthest planes is δtmax. Thus the ceramic heater 10 may be able to disperse the effect of thermal shocks into the direction of thickness t of the ceramic substrate 12 while at the same time able to maintain the uniformity of heating over the entire ceramic substrate 12.

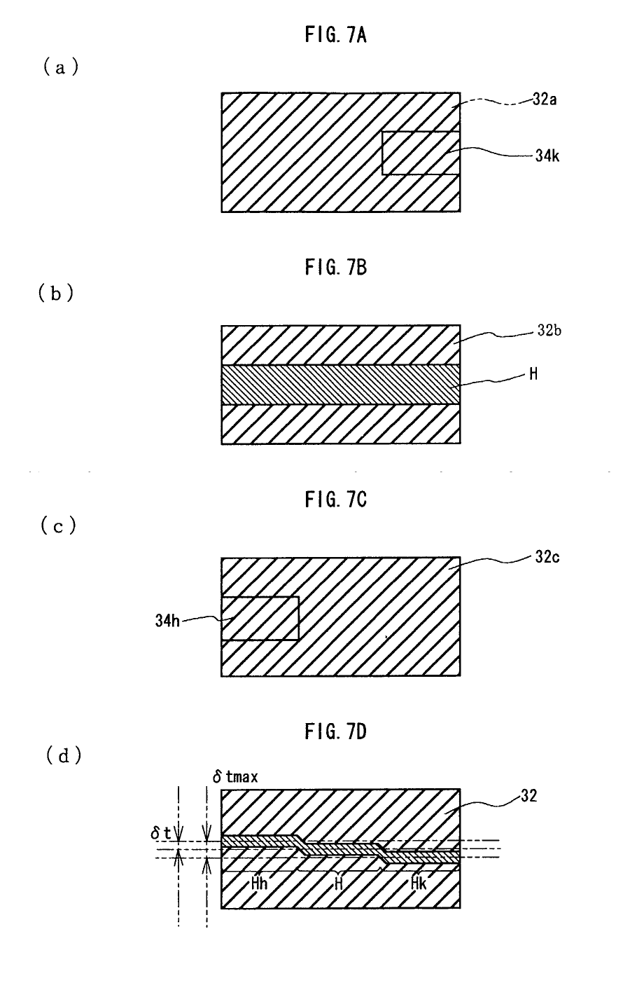

The configuration of the ceramic heater 10 may not be limited to the above-mentioned embodiment. For example, the ceramic heater 10 may be arranged such that some of heat generation bodies H is displaced along with the longitudinal axis of the heat generation bodies H, on the horizontal level (see FIG. 7).

Now a method of producing the ceramic heater in accordance with the present invention will be described below in greater details.

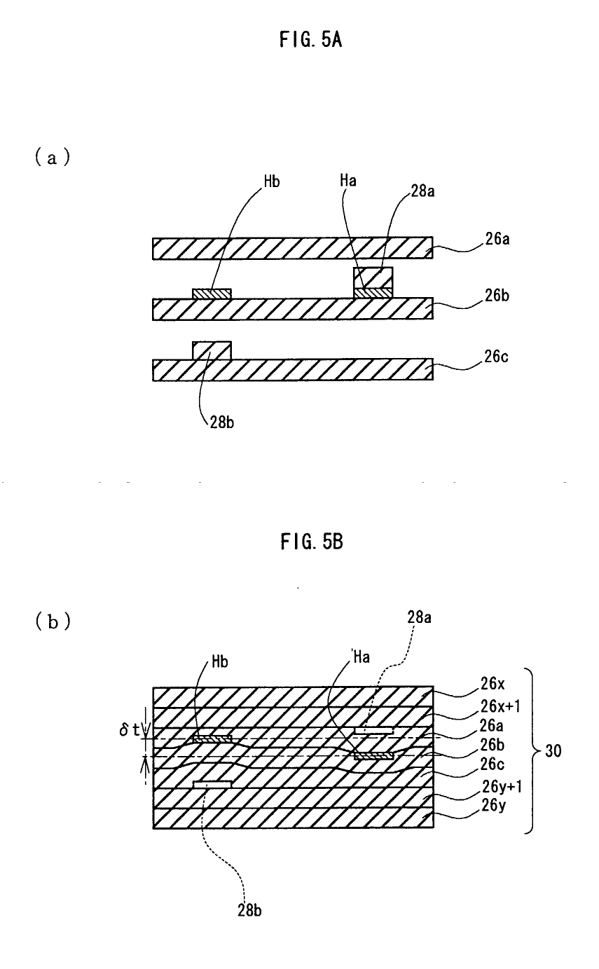

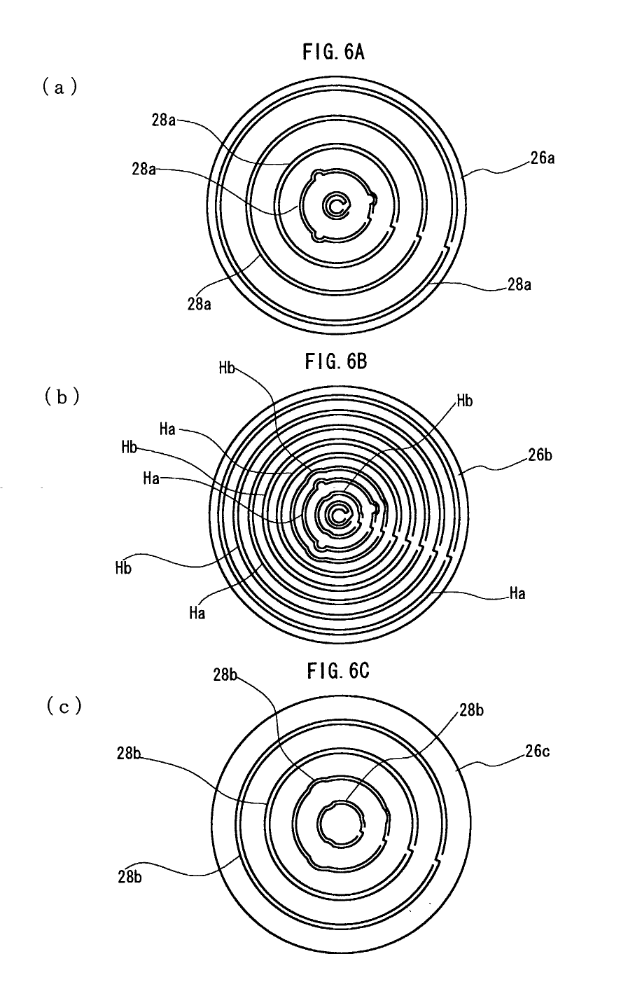

Referring to FIG. 5, there is shown a schematic diagram illustrating a method of producing a ceramic heater, in which a heat generation body Ha is disposed offset from another heat generation body Hb. The arrangement shown in this figure is prior to baking.

As shown in FIG. 5(a), by making use of a conventional process of the green sheet production method, on a lower green sheet 26c beneath the heat generation body Hb or above the heat generation body Ha, in the size capable to cover the heat generation body Ha, a paste layer 28b and 28a are formed, by applying and drying paste containing powdered aluminum nitride (also referred to as ‘paste’ hereinbelow).

Then, as shown in FIG. 5(b), on the upper side of green sheets 26a through 26c, a predetermined plurality of green sheets 26x, 26x+1, . . . (only two of them are illustrated in the figure) are superposed thereon which may constitute part of ceramic substrate, and under the lower side, a predetermined plurality of green sheets 26y, 26y+1, . . . (only two of them are illustrated) are superposed thereon to laminate and to pressurize together. In this manner a laminated green sheet body 30 can be obtained in which the heat generation bodies Ha and Hb are offset one from another.

Although the layer formed by using some paste as described above is described as a paste layer, because of the method of production thereof, the applied layer is not in form of paste after drying, rather in the form of film. Also in FIG. 5(b), the paste layers 28a and 28b are shown by dotted lines since these layers may be integrated into the lamination structure of the laminated green sheet body 30 because the step height of the thickness of layers is absorbed. It will be further described about the paste below.

When providing a paste layer above or beneath a heat generation body, the paste layer may be formed in direct contact with the heat generation body, or the paste layer may be provided by appropriately interposing one or a plurality of green sheets therebetween. However, it should be noted that when providing a paste layer just beneath a heat generation body, the order of forming a heat generation body and a paste layer has to be reversed because the paste layer should be applied onto the surface of a green sheet at first. In other words, according to FIG. 5(a), a paste layer 28b would be interposed between the heat generation body Hb and the green sheet 26b.

A method of production of one exemplary ceramic substrate 12 having mutually adjoining heat generation bodies disposed offset each from other will be described below in greater details in the order of process of the green sheet production. In particular the difference from the conventional sheet production method will be detailed. The description will be omitted on the same processes or similar to the conventional process.

In general, for the production of green sheets, a predetermined amount of binder, solvent, sintering agent and the like is added to the powdered aluminum nitride material, in accordance with the predetermined composition, then the obtained mixture is put into a ball mill and the like to mull for a predetermined period of time to prepare a slurry. Well-known materials such as powdered aluminum nitride and sintering agent may be used.

For the binder for green sheets, at least one selected from a group consisted of acrylic resin, ethyl cellulose, butylcellosorb and polyvinyl alcohol is preferred. For the solvent, at least one selected from a group consisted of α-terpineol and glycol is preferred. In the present invention, acrylic resin is used for the binder. The acrylic resin is solvent-soluble, feasible to achieve flexibility and sheet strength, has good formability such as high accuracy and precision, as well as thermal-decomposition. The acrylic resin has been more frequently used for the forming of ceramic materials recently.

A base film is based on a material such as polyethylene terephthalate (PET) and is surface processed so as to be flat, smooth and mold-releasable in order to assure that the green sheets are formed at a constant thickness.

The slurry are used for forming green sheets of a predetermined size and shape in accordance with the method already established for forming shaped sheets, such as doctor blade method. The slurry also is used for the paste to be applied when forming the paste layers. Producing thin layer of sheets is not limited to the doctor blade method, and it may be a shaping method with flat-rolling process. In order to shape a green sheet by means of the doctor blade method, a doctor blade machine incorporating a doctor blade, base films and a drying kiln may be used.

The slurry are pulled out of the gap between the doctor blade machine and the base film along with the transfer of the base film, to be shaped in the form of thin film. The thickness of slurry may be adjusted by the gap to quantitatively roll out a predetermined amount thereof on the base film, and thus resulting slurry will be transferred to the drier kiln together with the base film. The thickness of the green sheet may be preferably in the range of 0.1 to 5 mm. In the furnace, the volatile component of solvent contained in the slurry and the like will evaporate and the sheet will be dried and will become in a form of thin film resin, thus a green sheet can be obtained.

As will be described later, for the purpose of facilitating the integration of a green sheet laminated body with the interposed paste layers and of preventing the artifacts in the green sheet laminated body such as peel-off around the paste layers after baking the laminated body, it is preferable for the green sheet to have a thickness in the range of 0.2 to 0.7 mm, a density in the range of 1.7 to 2.3 g/cm³ and to have appropriately a thermal flexibility (deformability).

The heat generation bodies may be produced in predetermined position on the green sheet. The heat generation bodies may be shaped to the form of a circle or a rectangle in plane view. After baking the green sheet laminated body, heat generation bodies will be deposited thereon. Some heat generation body paste will be used which contains conductive components that may be heated by Joule heat when applying power thereto, in accordance with a process already established in the art such as the screen printing process and the like to form heat generation bodies in any given region specified on the surface of the green sheet. In general, for defining such given regions, a metal mask which provides a mask having patterns of such regions may be used.

For conductive composition contained in a heat generation body paste, tungsten or molybdenum carbide will be preferred because these materials are not only readily subject to be oxidized but also to be decreased thermal conductivity. As the metal particles, for example, any of tungsten, molybdenum, platinum, nickel, and the like, or more than two thereof may be used. The mean particle size of these conductive ceramic particles and these metal particles may be in the range of 0.5 to 3.0 μm.

A suitable heat generation body paste may include 85 to 97 parts by weight of conductive material, 1.5 to 10 parts by weight of at least one binder selected from a group consisted of acrylic resin, ethyl cellulose, butylcellosorb and polyvinyl alchol, 1.5 to 10 parts by weight of at least one solvent selected from a group consisted of α-terpineol, glycol, ethyl alcohol and butanol, these are mixed and uniformly mulled to prepare a suitable paste.

For the heat generation bodies, the heat generation body paste may be preferred because it can be baked integratedly after forming green sheet laminated body, however any other material may be used instead, which has the composition and shape that can be formed on a green sheet and applied to a ceramic substrate.

Next, the process of applying paste layers and the process of laminating and pressurizing will be described below. Referring to FIG. 6, there is shown a plan view showing primary layers when laminating green sheets in the order of (a) to (c) from the topmost layer. FIG. 6(a) shows only a paste layer configured according to the arranging pattern. This patterned layer 28a will be superposed on the heat generation body Ha shown in FIG. 6(b).

The heat generation bodies Ha and Hb are schematically illustrated on FIG. 6(b) on the same plane (the drawing plane). Here, the heat generation bodies are designated to Ha and Hb because, after laminating and pressurizing, the heat generation body Ha will be displaced to lower side, the heat generation body Hb will be displaced to upper side.

In the process of forming paste layers, heat generation bodies Ha and Hb will be formed on a green sheet 26b, in accordance with the pattern shown in FIG. 6(b). Then, a paste layer 28a will be formed, in accordance with the pattern shown in FIG. 6(a), over the heat generation bodies Ha (see FIG. 6(b)), which is made by applying paste containing powdered aluminum nitride thereto and by drying. Thereafter, another paste layer 28b will be formed on the green sheet 26c in accordance with the pattern shown in FIG. 6(c). The paste layers may preferably have a sufficient surface area to cover the heat generation bodies.

In other words, with respect to the position of formed heat generation bodies Ha (see FIG. 6(b)), the paste containing powdered aluminum nitride will be applied and dried on areas on another green sheet just above (reference numeral 28a of FIG. 6(a)), or on areas on still another green sheet beneath (reference numeral 28b of FIG. 6(c)) the position of heat generation bodies when laminating and pressurizing green sheets to form paste layers. When applying paste layers, the thickness may be adjusted by repeating applying and drying (i.e., applying for many times), and the offset δt may be modified.

Paste containing powdered aluminum nitride may contains the same materials as that constituting green sheets; the paste can be prepared by mixing some organic binders and solvent for the purpose that a layer of aluminum nitride may selectively formed on some specific areas by way of applying the paste by printing or the like and drying the same. The paste can also be prepared by vacuum degassing or heating of the slurry to increase the viscosity to 50,000 to 200,000 cps (50 to 200 Pa·s). Sintering agent such as lithium oxide, calcium oxide, rubidium oxide, yttrium oxide, alumina and the like may also be added thereto.

The lamination and bonding process will be described below in greater details. In the order from the topmost to the bottom, (1) a desired number of plurality of plain green sheets (not shown), (2) a green sheet 26b described as FIG. 6(b) above with the paste layer 28a formed in accordance with the pattern FIG. 6(a) just above the heat generation bodies Ha, (3) green sheets 61 c of FIG. 6(c) at lower side, and (4) a desired number of plurality of plain green sheets (not shown) are compiled so as to sandwich the green sheet 26b subject to form heat generation bodies Ha and Hb shown in FIG. 6(b).

Thereafter, each of patterns shown in FIGS. 6(a) to (c) will be compiled as have been described above. In other words, under the condition of interposing the paste layers between a plurality of green sheets, the entire layers will be laminated and pressurized in the direction of thickness to be bonded together.

In the case where a green sheet laminated body is made by providing paste layers in accordance with the patterns shown in FIG. 2 or FIG. 3, the process will be the same as above description. In other words, if a lamination is made in accordance with the pattern shown in FIG. 2, the green sheet laminated body may be made by sequentially altering the thickness of each paste layer or by changing of green sheets subject to provide heat generation bodies and paste layers. Also, if a lamination is made in accordance with the pattern shown in FIG. 3, then a green sheet laminated body may be made by grouping the green sheets 26a to 26c as described above to a group to laminate a plurality of groups for plural times at every predetermined distance.

Referring to FIG. 7, a configuration with some of heat generation bodies being produced in positions offset along with the longitudinal axis of the heat generation bodies in a plane will be described below in greater details. With respect to the green sheet 32b with heat generation bodies H, in the upper surface thereof, a paste layer 34k will be formed over the heat generation bodies H in accordance with the pattern 34k; in the lower surface, a paste layer 34h will be formed on a green sheet 32c. Then, as similar to the case shown in FIG. 5(b), other green sheets will be superposed thereon to produce the green sheet laminated body 32 as shown in FIG. 7(d). The pattern 34k and the pattern of heat generation bodies H are preferably coaxial.

As have been described in the foregoing discussion, in both the case where mutually adjoining heat generation bodies are disposed offset one from another, and the case where some heat generation bodies are disposed offset from others along with the longitudinal direction of heat generation bodies, the present invention differs from the conventional technique in that a step of providing paste layers is added. The paste is composed of the same powdered ceramics as used for green sheets, the application and drying of paste layers may require for a mask to be prepared. However, these steps are well known in the art and the process of forming paste layers may be readily achieved without significant changes from the conventional production process.

When forming paste layers, since some heat generation bodies are selectively offset from others in the direction of thickness of ceramic substrate, the formation of paste layers may be quantitatively set. The amount of positional offset may be increased by applying for many times. Furthermore, the application and drying are the techniques well established in the art, so that the positional offset of heat generation bodies may be obtained with good repeatability.

In the present embodiment, the lamination bonding process is preferably the thermo-compression bonding, in order to form paste layers with heat generation bodies offset in the direction of thickness of ceramic substrate and to allow green sheets to buffer the step height caused by the paste layers to well contact to the green sheet laminated body.

The preferred condition of thermo-compression bonding at the temperature of 130° C. with the pressure of 80 kgf/cm² is suitable for well contacting the paste layers with the green sheet laminated body. Also, the green sheet laminated body may be cut to the desired shape to conform to the ultimate size and shape of green body before sintering.

The method of production as have been described above allows laminated green sheets to be bonded with the paste layers interposed, so that the green sheet with the heat generation bodies selectively offset by the thickness of a paste layer in the direction of thickness may be readily produced. In accordance with the preferred embodiment as described above, a ceramic substrate may be produced in which the amount of positional offset of the heat generation bodies in the direction of thickness may be variably set, without significantly changing the conventional production process, at lower cost.

In accordance with the process of forming paste layers and the process of lamination bonding as have been described in the foregoing description, with respect to the direction of thickness of a ceramic substrate, heat generation bodies or at least some of heat generation bodies may be readily and quantitatively displaced to an offset for positioning in a different horizontal plane offset from the plane of other heat generation bodies.

Thereafter, thus obtained green body may be inserted into a crucible or a setter and the like to decompose and degrease the binder and the like under the temperature of 300 to 500° C. for a predetermined temperature and for a predetermined period of time. Then the green body will be sintered at approximately 1800° C. for a predetermined period of time. A desired ceramic substrate having heat generation bodies can be obtained through those processes as described above.

Thereafter by attaching power supply terminals and connecting to a casing, a ceramic heater can be completed.

In this preferred embodiment the present invention is applied to an exemplary heater having power supply connector terminals, the present invention may also be equally applied to a wafer probe with heat generation bodies by forming chuck-top conductor layer on the surface of ceramic substrate, and ground and guard electrodes within the ceramic substrate. The present invention may still be applied to an electrostatic chuck with heat generation bodies by embedding electrostatic electrodes within the ceramic substrate. As can be appreciated from the foregoing description, the present invention can be equally applied to any of applied products, which have a structure similar to that with built-in heat generation bodies.

Another embodiment of the present invention will be described below. In this embodiment, green sheet lamination is similar to the preceding embodiment, except for a mold 36 used, which has a convex or concave surface, as shown in FIG. 8. Furthermore, a ceramic heater may be produced by adding additional five to fifty green sheets attached to both upper and lower sides, then sintering the green body under a high pressure and high temperature condition (see FIG. 8(a) and (b)) to once produce a curved ceramic substrate 40, then flattening both the upper and bottom surface by trimming (see FIG. 8(c)). The amount of bending in the convex or concave surface may be preferably in the range of 3 to 500 μm in order to assure the maximum amount of offset δtmax. The trimming amount may be preferably in the range of 5 to 1000 μm, in order to assure the flatness.

In FIG. 8, through holes 42 are provided for heat generation bodies H, and terminals 44 made of cobalt or stainless steel are attached thereto (see FIG. 8(d)). The temperature will be decreased around the center portion due to the heat dissipation by conduction through the terminals 44. While configuration shown in FIG. 8 is unlikely to decrease the temperature because the heat generation bodies H close to the center portion are located nearer the heating plane.

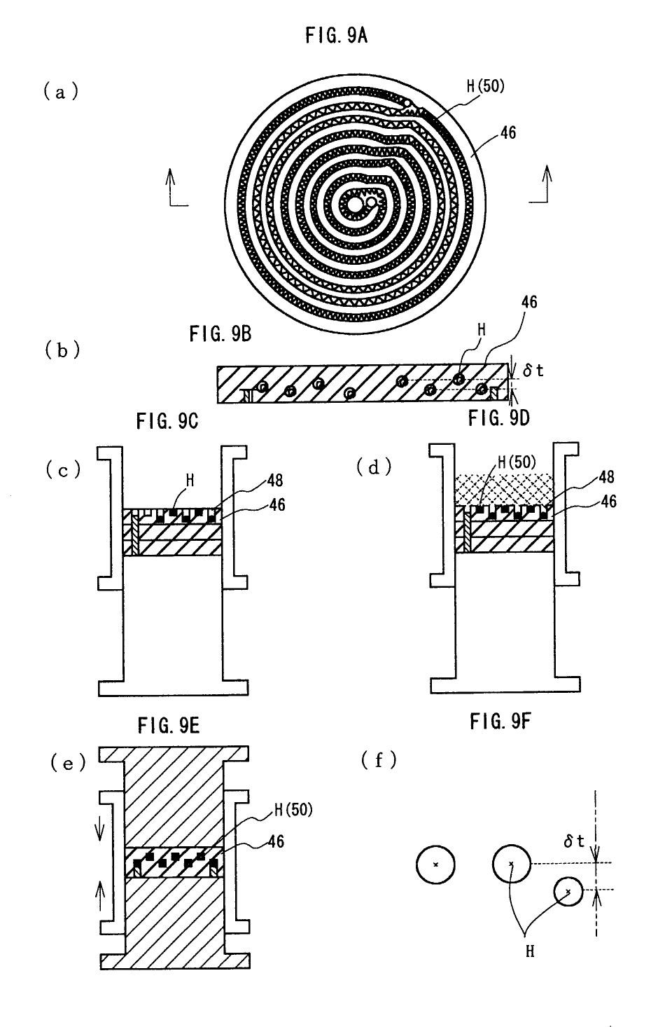

Now still another embodiment will be described with reference to FIG. 9. FIG. 9(a) and (b) show a plan view and cross-sectional side elevation view indicating the arrangement of heat generation bodies H; FIG. 9(c) to (e) show flow diagrams indicating process of arranging heat generation bodies H. As shown in these figures, a green body 46 may be produced at first, then a groove 48 may be provided on the surface of the green body 46 (see FIG. 9(c)). The groove 48 may be formed by spot facing, or may be formed in the green sheet in advance. The width and depth of groove may be adjusted to the width and thickness of the (spiral) heat generation bodies H, respectively. More specifically, the width of spiral coil is 1 to 10 mm, thickness 0.1 to 2 mm, the groove should accept this coil. The aspect ratio (width/thickness) of cross-section of the coil is preferably 1 through 10 so as to assure the uniform temperature distribution over the entire wafer-heating surface. The location of heat generation bodies may be offset by changing the depth of adjacent grooves before assembly.

Then after fitting the heat generation bodies H into the groove 48 (see FIG. 9(d)) and providing powdered ceramics thereto so as to cover the heat generation bodies, the green body will be sintered under a high temperature and high pressure of 1600 to 2000° C., 9.8 to 49 MPa·s, 100 to 500 kgf/cm² (see FIG. 9(e)).

Some examples carrying out the present invention will be disclosed hereinbelow, it should be understood that these examples are disclosed by way of examples and that the present invention is not to be limited thereto.

### EXAMPLES

### Example 1

(1) A ceramic paste composition (viscosity 100 Pa·s) was made by mixing 100 parts by weight of powdered aluminum nitride (available from Tokuyama Corp., mean particle diameter 1.1 μm), 4 parts by weight of yttrium (mean particle diameter 0.4 μm), 11.5 parts by weight of acrylic binder, 0.5 part by weight of dispersant, and 53 parts by weight of alcohol mixture containing 1-butanol and ethanol. By means of doctor blade method, sheet formation was made from the paste on a base film comprised of PET and the like to obtain a green sheet of thickness of 0.47 mm. Some openings for making through holes were punched out at predetermined positions on the green sheet.

(2) A conductive paste composition A was prepared by mixing 100 parts by weight of tungsten carbide having mean particle diameter of 1 μm, 3.0 parts by weight of acrylic binder, 3.5 parts by weight of α-terpineol solvent, and 0.3 part by weight of dispersant.

Also, a conductive paste B was prepared by mixing 100 parts by weight of tungsten carbide having mean particle diameter of 3 μm, 1.9 parts by weight of acrylic binder, 3.7 parts by weight of α-terpineol solvent, and 0.2 part by weight of dispersant.

(3) By means of screen-printing method, heat generation body pattern was printed with the conductive paste A, and the openings for through holes were filled with the conductive paste B.

Over every two heat generation bodies patterns a layer was printed with the ceramic paste composition of (1) at thickness of 100, 250 and 1200 μm.

(4) Thus prepared green sheet was dried at 80° C. for five hours, 20 green sheets of thickness 0.5 mm, on which heat generation bodies pattern and paste layers were formed, were laminated and bonded with a pressure of 80 kg/cm², temperature of 130° C. to integrate to produce a green sheet laminated body.

For this example (inventive product), the pattern shown in FIG. 1 or the pattern shown in FIG. 2 was used for the arrangement pattern of heat generation bodies and paste layers. A control (made by conventional method) was provided which has the heat generation bodies on a single plane.

(5) Thus obtained green sheet laminated body was degreased at 600° C. for five hours under a nitrogen environment, hot-pressed at approximately 1890° C., pressure 150 kg/cm² for three hours to obtain a ceramic substrate in the form of aluminum nitride plate with thickness of 4.2 mm. The resulting ceramic substrate was cut to a disk of diameter of 210 mm, attached to power supply terminals, and connected to a casing.

### Example 2

(1) A ceramic paste composition (viscosity 100 Pa·s) was made by mixing 100 parts by weight of powdered aluminum nitride (available from Tokuyama Corp., mean particle diameter 1.1 μm), 4 parts by weight of yttrium (mean particle diameter 0.4 μm), 11.5 parts by weight of acrylic binder, 0.5 part by weight of dispersant, and 53 parts by weight of alcohol mixture containing 1-butanol and ethanol. By means of doctor blade method, sheet formation was made from the paste on a base film comprised of PET and the like to obtain a green sheet of thickness of 0.47 mm. Some openings for making through holes were punched out at predetermined positions on the green sheet.

(2) A conductive paste composition A was prepared by mixing 100 parts by weight of tungsten carbide having mean particle diameter of 1 μm, 3.0 parts by weight of acrylic binder, 3.5 parts by weight of α-terpineol solvent, and 0.3 parts by weight of dispersant.

Also, a conductive paste B was prepared by mixing 100 parts by weight of tungsten carbide having mean particle diameter of 3 μm, 1.9 parts by weight of acrylic binder, 3.7 parts by weight of α-terpineol solvent, and 0.2 parts by weight of dispersant.

(3) By means of screen-printing method, heat generation body pattern was printed with the conductive paste A, and the openings for through holes were filled with the conductive paste B.

(4) A green sheet having heat generation body pattern and conductive paste printed thereon and 30 sheets of intact green sheets were fit into a fixture having a convex plane of 500 μm height as shown in FIG. 8. This green sheet laminated body was degreased at approximately 600° C. for five hours under a nitrogen environment, hot-pressed at approximately 1890° C., pressure 14.7 MPa·s (150 kg/cm²) for three hours to obtain a ceramic substrate in the form of aluminum nitride plate with thickness of 6.0 mm. The resulting ceramic substrate was trimmed on both side by 1 mm to flatten the surface at the level of flatness of 3 μm. The trimmed ceramic substrate was cut to a disk of diameter of 210 mm, then the opposite side of the wafer heating surface was polished to provide recesses of depth 1 millimeter. Power supply terminals were attached to the through holes exposed in the recesses, and connected to a casing.

### Example 3

(1) 100 parts by weight of powdered aluminum nitride (available from Tokuyama Corp., mean particle diameter 1.1 μm), 4 parts by weight of yttrium (mean particle diameter 0.4 μm ), 11.5 parts by weight of acrylic binder were housed in a mold to pressurize at 14.7 MPa·s (150 kg/cm²) to obtain a green body of thickness 7 mm.

(2) The surface of green body was spot faced by means of a bit of diameter 2.5 mm to form spiral groove. One green body was spot faced in depths of 0.5 mm and 1.7 mm for every two rounds, another was spot faced in depths of 0.5 mm and 0.75 mm for every two rounds, so that the cross-section became a hatch.

(3) A tungsten wire was wound spirally. heat generation body having cross-section of 2.5 mm by 0.5 mm was disposed along with the groove. A mixture of 100 parts by weight of powdered aluminum nitride (available from Tokuyama Corp., mean particle diameter 1.1 μm), 4 parts by weight of yttrium (mean particle diameter 0.4 μm), and 11.5 parts by weight of acrylic binder was put thereon. Then the body was pressed at a pressure of 14.7 MPa·s (150 kg/cm²) to obtain a molded green body of thickness 15 mm.

(4) Thus obtained mold body was degreased at 600° C. for five hours in a nitrogen environment, hot-pressed at a temperature of approximately 1890° C. and a pressure of 14.7 MPa·s (150 kg/cm²) for three hours to obtain a ceramic substrate in a form of plate of aluminum nitride with thickness 6.0 mm.

### Comparative Example 1

Comparative Example 1 was made identical to example 1, except for that the ceramic paste was not printed.

### Comparative Example 2

Comparative Example 2 was made identical to example 1, except for that the ceramic paste was printed at a constant thickness of 1500 μm.

### Comparative Example 3

Comparative Example 3 was made identical to example 3, except for that the depth spot faced was unified to 0.5 mm in every turn.

### Comparative Example 4

Comparative Example 4 was made identical to example 3, except for that the depth spot faced was alternately 0.5 mm and 6.0 mm.

### Example 4

A ceramic heater incorporating heat generation bodies and electrostatic electrodes for electrostatic chuck was produced as fourth example. This ceramic heater will now be described below in greater details.

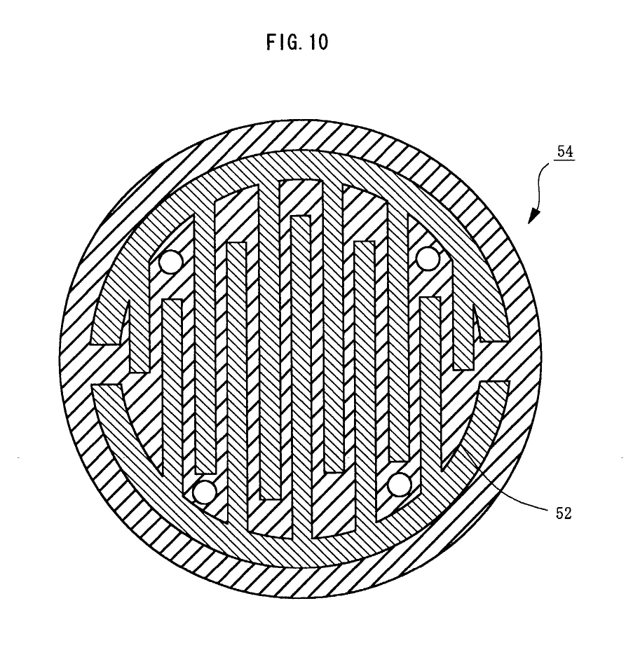

(1) on a ceramic substrate described as example 3, the conductive paste A of example 2 was applied to print comb-tooth electrodes 52 as shown in FIG. 10.

(2) After laminating the green sheets of example 2 thereon, the ceramic substrate body was hot-pressed at a temperature of approximately 1890° C., a pressure of 150 kg/cm² for three hours to form an electrostatic chuck having dielectric film of thickness 300 μm. The ceramic heater 54 in accordance with Example 4 thereby may be used as an electrostatic chuck.

### Example 5

A ceramic substrate incorporating heat generation bodies and electrodes for wafer probe therein and on the surface was made as fifth example. This ceramic substrate example will be now described below in greater details.

(1) Ground electrodes were printed on a ceramic substrate of Example 3 by using the conductive paste B of Example 2.

(2) Guard electrodes were printed on a green sheet of Example 2 by using the conductive paste B.

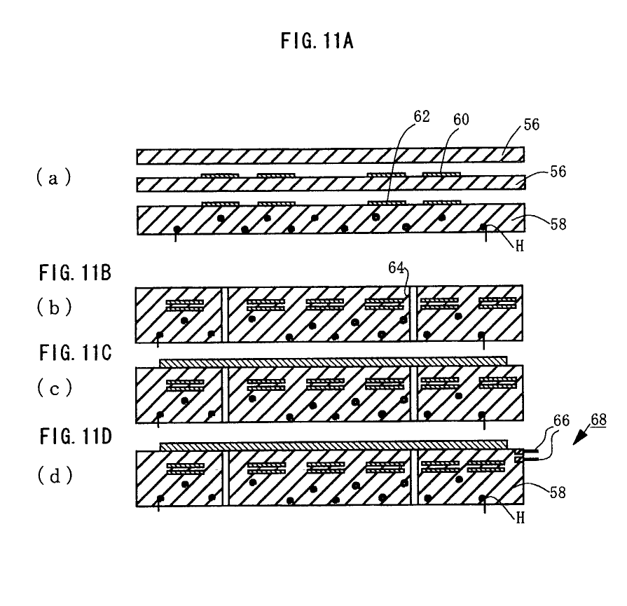

(3) As shown in FIG. 11(a), the green sheet 56 and ceramic substrate 58 were laminated, hot-pressed at a temperature of approximately 1890° C., a pressure of 150 kg/cm² for three hours to obtain the ceramic substrate 58 incorporating guard electrodes 60 and ground electrodes 62 therein.

(4) Some passing-through holes 64 were drilled (see FIG. 11(b)).

(5) A porous metal plate made from powdered tungsten of mean particle size of 3.0 μm sintered at 1900° C. was mounted on the ceramic substrate as described in (4) above, by means of silver soldering paste, and bonded by heating to a temperature of 970° C. (see FIG. 11(c)).

(6) Holes were opened on a side wall of the ceramic substrate 58 to soldering terminal pins 66 by using soldering paste containing 80% of Sn and 20% of Pb and heating to a temperature of 300° C. to obtain a wafer probe 68.

[Evaluation]

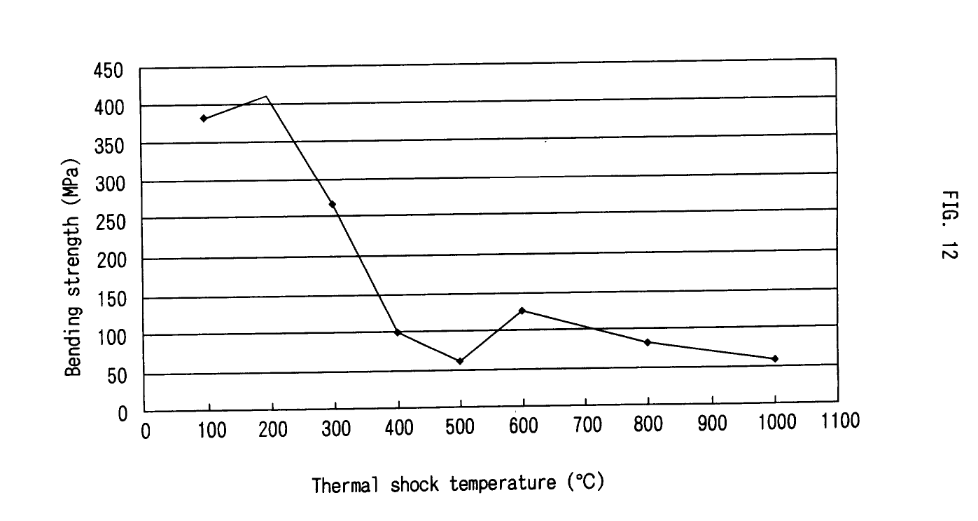

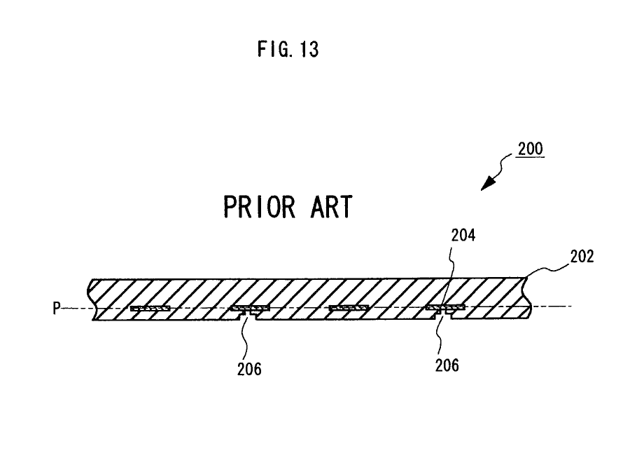

Samples of Examples 1 to 3 and Comparative Examples were subjected to measure the amount of displacement in the cross-section plane by means of an optical microscope (available from SOKIA, model No. SI-7055 MB), then thermal shock test was performed. The result is given in Table 1. In the Table 1, ΔT designates to ‘anti thermal shock property’, which is better when ΔT is larger. The ΔT was measured as follows: samples in a dimension of 3 mm×4 mm×40 mm was dissected so as to include the heat generation body, the samples were heated to a predetermined temperature (400° C.), then dropped into water to give thermal shock. After the thermal shock experiment, a bending strength test was performed by using an autograph, available from Shimadzu Corp., to determine the temperature of abrupt decrease of strength as the ΔT. One example of results is given in FIG. 12.

Also, the difference of temperature in the wafer heating surface when heated was measured by a thermo-viewer (available from Nippon Datum Co. Ltd., mode No. IR162012-0012). The results are given in Table 1.

TABLE 1

| | | Thickness | Maximum | Offset to | | |
|---|---|---|---|---|---|---|
| | | of paste | offset | adjacent | | Temperature |
| | Disposition | layer | (μm) | body | ΔT (° C.) | (° C.) |
| Example 1 | cross- | 100 | 40 | 40 | 190 | 10 |
| | hatched | | | | | |
| | | 250 | 100 | 100 | 200 | 8 |
| | | 1200 | 480 | 480 | 190 | 10 |
| Example 2 | upper | | 498 | 50 | 200 | 8 |
| | convex | | | | | |
| Example 3 | cross- | | 500 | 500 | 190 | 9 |
| | hatched | | | | | |
| | cross- | | 100 | 100 | 190 | 8 |
| | hatched | | | | | |
| Comparative | | | 0 | 0 | 150 | 9 |
| Example 1 | | | | | | |
| Comparative | | | 600 | 600 | 160 | 20 |
| Example 2 | | | | | | |
| Comparative | | | 0 | 0 | 150 | 10 |
| Example 3 | | | | | | |
| Comparative | | | 2200 | 2200 | 160 | 20 |
| Example 4 | | | | | | |

When comparing the anti thermal shock property of the examples with that of Comparative Examples, the anti thermal shock property of Examples in accordance with the present invention was higher, ΔT=190 to 200 (° C.), while the anti thermal shock property of Comparative Examples was lower, ΔT=150 to 160 (° C.). It has been revealed that the anti thermal shock property was improved by providing at least some of heat generation bodies at positions offset from others in the direction of thickness of ceramic substrate. Among others the samples derived from Example 1 (paste layer thickness 250 μm) and Example 2 showed significantly excellent anti thermal shock property ΔT=200° C.

When comparing the Examples with Comparative Examples in terms of the uniformity of temperature of the ceramic substrates, the difference of temperature in Examples was within 8 to 10° C., in a range relatively small, while that of the Comparative Examples was in a broader range of 10 to 20° C. The offset arrangement of at least some of heat generation bodies from others in the direction of thickness of the ceramic substrate was found to be effective for the uniformity of temperature in the ceramic substrate.

Next, the ceramic heater according to the Example 4 was examined to determine whether or not it can be used as an electrostatic chuck. For the samples of Example 4, there was not found any crack and the like when heating to 300° C. for 30 seconds. In addition, a traction force of 1 kgf/cm² (9.8×10⁴ Pa) was confirmed with the application of 1 kV. From above findings the ceramic heater in accordance with Example 4 may be used as an electrostatic chuck.

Next, the ceramic heater according to the Example 5 was examined to determine whether or not it can be used as a wafer probe. For the samples of Example 5, there was not found any crack and the like when heating to 200° C. for 20 seconds. There was no malfunction when performing conductive test of wafers at 200° C. From above findings the ceramic heater in accordance with Example 5 may be used as a wafer probe.

The present invention may be embodied in other specific forms without departing from the spirit or essential characteristics thereof. For instance, ceramic substrates in accordance with the embodiments as described above comprise either a configuration in which mutually adjoining heat generation bodies are offset to different horizontal planes, or a configuration in which some of heat generation bodies are displaced to another horizontal plane along with the longitudinal direction of the heat generation bodies. However, an appropriate combination of those two configurations is also encompassed within the spirit and scope of the present invention. In brief, the concept of the present invention may be achieved if one or more of heat generation bodies disposed within a ceramic substrate is located offset from others within the ceramic substrate in the direction of height thereof.

A ceramic heater according to claim 1 to claim 10 in accordance with the present invention has at least part of heat generation means disposed within a ceramic substrate, offset to a level different from that of others of the heat generation means in the direction of thickness of the ceramic substrate. The offset formation of at least part of heat generation means to a level different from that of others of the heat generation means may cause the expansion or shrinkage of heat generation bodies to be occurred at levels different each other. Therefore the ceramic heater in accordance with the present invention may disperse thermal shocks to entire ceramic substrate to reduce the effect thereof, and may achieve better anti thermal shock property. In addition, the ceramic heater in accordance with the present invention does not decrease uniformity of heating characteristics on the wafer-heating surface.

What is claimed is:

1. A ceramic heater, comprising:
a ceramic substrate; and
heat generation means disposed within said ceramic substrate, at least part of said heat generation means being disposed on an offset level different from that of others of said heat generation means in the direction of thickness of said ceramic substrate.

2. The ceramic heater according to claim 1, wherein said heat generation means are disposed such that a level of adjoining ones to others is offset in the direction of thickness of said ceramic substrate.

3. The ceramic heater according to claim 1 or 2, wherein said heat generation means is flat in cross-section.

4. The ceramic heater according to claim 3, wherein an amount of offset displacement in level of mutually adjacent heat generation means is in a range of 1 to 100 μm.

5. The ceramic heater according to claim 4, wherein a maximum amount of offset displacement of said heat generation means is in the range of 3 to 500 μm.

6. The ceramic heater according to claim 3, wherein a maximum amount of offset displacement of said heat generation means is in the range of 3 to 500 μm.

7. The ceramic heater according to claim 1 or 2, wherein an amount of offset displacement in level of mutually adjacent heat generation means is in a range of 1 to 100 μm.

8. The ceramic heater according to claim 7, wherein a maximum amount of offset displacement of said heat generation means is in a range of 3 to 500 μm.

9. The ceramic heater according to claim 1 or 2, wherein a maximum amount of offset displacement of said heat generation means is in a range of 3 to 500 μm.

10. The ceramic heater according to claim 1 or 2, wherein said heat generation means comprises a spiral wire body.

11. The ceramic heater according to claim 10, wherein an amount of offset displacement in level of mutually adjacent heat generation means is in a range of 1 to 500 μm.

12. The ceramic heater according to claim 11, wherein a maximum amount of offset displacement of said heat generation means is in a range of 5 to 2000 μm.

13. The ceramic heater according to claim 10, wherein a maximum amount of offset displacement of said heat generation means is in a range of 5 to 2000 μm.

14. The ceramic heater according to claim 1 or 2, wherein an amount of offset displacement in level of mutually adjacent heat generation means is in a range of 1 to 500 μm.

15. The ceramic heater according to claim 14, wherein a maximum amount of offset displacement of said heat generation means is in a range of 5 to 2000 μm.

16. The ceramic heater according to claim 1 or 2, wherein a maximum amount of offset displacement of said heat generation means is in a range of 5 to 2000 μm.

17. The ceramic heater according to claim 1 or 2, wherein electrostatic electrodes are provided on said ceramic substrate.

18. The ceramic heater according to claim 1 or 2, wherein a chuck-top conductor layer is formed on the surface of said ceramic substrate.
